(19) United States
(12) Patent Application Publication
(10) Pub. No.: US 2023/0028204 A1
(43) Pub. Date: Jan. 26, 2023

(54) METHOD FOR PRODUCING COOKED EGG PRODUCT HAVING CONTROLLED CURD SIZE AND/OR SHAPE

(71) Applicant: MICHAEL FOODS, INC., Minnetonka, MN (US)

(72) Inventors: DANIEL L. VANCE, ACWORTH, GA (US); KATIE ANN WIDI, BELLE PLAINE, MN (US); PETER J. KOCH, GAYLORD, MN (US); DARREN D. SAFFERT, LAFAYETTE, MN (US); MATTHEW J. BET, NEW MARKET, MN (US); WANDA P. PAINE, GAYLORD, MN (US); TODD D. BOHMAN, WACONIA, MN (US)

(73) Assignee: MICHAEL FOODS, INC., MINNETONKA, MN (US)

(21) Appl. No.: 17/787,315

(22) PCT Filed: Dec. 19, 2020
(86) PCT No.: PCT/US2020/066265

§ 371 Date: Jun. 19, 2022

Related U.S. Application Data
(60) Provisional application No. 62/950,887, filed on Dec. 19, 2019.

(51) Int. Cl. A23L 15/00; A23L 5/10

(52) U.S. Cl. CPC A23L 15/00; A23L 5/10

(57) ABSTRACT

A method and process for providing a cooked egg product having controlled curd shapes and few fines. By mechanically manipulating (e.g., dicing) a cooked egg product only after it has been cooled below a target setting temperature, resulting curds can be provided with a more controlled, even regular, shape as well as a low percentage of fines. Also presented is an egg composition with minimal fines and curds of cooked egg. The egg composition comprises cooked liquid egg, fines with a dimension less than 2.8 mm, and curds with a diameter less than 2.5 cm.

### CROSS-REFERENCE TO RELATED APPLICATION

This international application claims the benefit of U.S. provisional patent application No. 62/950,887, filed Dec. 19, 2019, the disclosure of which is incorporated herein by reference.

### BACKGROUND INFORMATION

Commercial egg product manufacturers cannot use traditional culinary equipment and techniques: the volumes with which they work are too large, and production speeds are too high. Those entities rely on production-scale equipment and associated techniques targeted at providing an end product with organoleptic properties that closely approximate those of a small scale, kitchen-made product.

Making scrambled eggs is a familiar culinary operation in much of the world, even being performed by many children.

Scrambled eggs can have curds ranging from small to large, as well as a variety of shapes, with the “correct” size and shape of the curds being a matter of personal preference of the cook and/or diner. Websites and videos extolling the benefits of, and techniques for producing, small, medium, large, and mixed size are plenteous.

The vast majority of those kitchen-based techniques are inapplicable to commercial production processes, however.

Commercial techniques and process for providing scrambled egg-type products are described in, for example, U.S. Pat. Nos. 4,388,340, 6,759,076, 7,069,844, 7,229,660, 7,264,840, 8,025,914, 8,268,379 and 9,888,710. Several of these describe methods for controlling egg curd size and shape.

Commercial scale scrambled egg-type products are used in a variety of packaged (i.e., made remotely from the point of heating and/or sale) breakfast food products including burritos, bowls, and sandwiches.

An issue faced by purchasers of commercially produced scrambled egg-type products is fines, which are pieces of the cooked egg product that can pass through a #7 sieve, i.e., —2.8 mm or smaller. Not only do purchasers of food products containing commercially produced scrambled eggs not like them (due to the tendency of fines not to stay in the food product during consumption), the producers of the food products do not like to deal with them during preparation. Commercial producers of the scrambled egg products do not like their negative effects on efficiency and throughput.

Reduction of fines and obtaining properly sized curds, while retaining commercial scale speeds and outputs, remains an ongoing issue for commercial producers of cooked egg products.

### SUMMARY

Hereinafter is described a process capable of providing a cooked egg product having controlled curd shapes while, simultaneously, producing very few fines, i.e., pieces having a dimension less than ˜2.8 mm. Even though the process uses the same basic steps of a commercial scale production process—cooking, mechanical manipulation, and cooling—it does so in an order that differs from those of previous techniques, thereby resulting in better control over shape and size of the resulting pieces.

By mechanically manipulating a cooked egg product only after it has been cooled below a target setting temperature, the resulting curds have a more controlled, even regular, shape. Advantageously, the amount of fines, disliked by producers, users and consumers, simultaneously is kept low.

Advantageously, the present process also provides advantages in terms of texture, appearance, flavor and throughput compared to many previously employed processes. In this regard, advantages are manifested as follows:
Texture—a higher firmness measurement using a texture measurement system or analyzer such as those sold by Food Technology Corp (Sterling, Va.) and Stable Micro Systems (Godalming, Surrey, UK);
Appearance—fewer than 5, preferably 2 or fewer, nodules, which results in good flowability and reduced bridging or clumping of the curds during processing prior to packaging;
Flavor—reduced numbers or amounts of starch(es), gum(s) and/or emulsifier(s) in an egg formulation, particularly one which includes particulates such as cheese, vegetables, meat, certain spices, etc.;
Throughput—a commercial scale process which produces at least 40, preferably at least 45, and more preferably at least 50 pounds of cooked egg product per minute.

The more detailed description that follows provides additional details which explain and exemplify the aforedescribed processes. The appended claims define the inventions in which exclusive rights are claimed, and they are not intended to be limited to particular embodiments shown and described, from which ordinarily skilled artisans can envision variations and additional aspects.

### DETAILED DESCRIPTION OF ILLUSTRATIVE EMBODIMENTS

The following discussion is presented to enable an ordinarily skilled artisan to make and use one or more of the disclosed embodiments. The general principles described herein may be applied to embodiments and applications other than those detailed below; therefore, the present embodiments are not intended to be limited to the particular embodiments shown, but are to be accorded the widest scope consistent with the principles and features disclosed or suggested herein.

The singular forms “a,” “an,” and “the” include plural referents unless the context clearly dictates otherwise.

That general description employs certain terms and phrases for the sake of brevity, clarity, and ease of understanding; no unnecessary limitations are to be implied therefrom because such terms are used for descriptive purposes and are intended to be broadly construed. However, the following definitions are intended to apply hereinthroughout, unless a contrary indication is provided by provided by surrounding text:
“nodule” means a small rounded or irregularly shaped protuberance on a curd;
“whole egg” means a mixture of egg white and yolk, which can be, but need not necessarily be, in the same ratio as those components appear in avian eggs;
“egg white” means that portion of a whole egg remaining after yolk is removed from a shelled avian egg;
“yolk” means that portion of a whole egg remaining after egg white is removed from a shelled avian egg;
“egg powder” means a dehydrated form of any of whole egg, egg white or yolk;
“reconstituted egg powder” refers to the product of mixing an egg powder with water;
“egg substitute” means low-cholesterol products containing egg white but having had yolk (or a substantial portion thereof) replaced by non-egg ingredients such as vegetable oil, nonfat dry milk, soy protein, gums, food coloring, artificial flavors, and vitamins and minerals;
“imitation egg” means a food-grade product derived primarily from plant-based sources but having functional properties similar to those of an avian egg; and
“liquid egg” means liquid whole egg, liquid egg white, liquid yolk, liquid egg substitute, reconstituted egg powder, liquid imitation egg, or any combination thereof.

Unless a portion of text specifically indicates otherwise, all percentages throughout this document are weight percentages, i.e., w/w.

The relevant portion(s) of any patent or publication specifically mentioned in the foregoing description is or are incorporated herein by reference.

As summarily described above, described herein is a process for preparing, on a commercial scale, a scrambled egg product having a controlled curd shape and few fines. This process advantageously can be run in both batch and continuous modes.

The process employs liquid egg as a starting material. The liquid egg can include one or combination of whole egg, egg white, egg yolk, egg substitute, egg powder, and imitation egg.

In certain embodiments, the liquid egg can include at least˜50%, preferably at least 80%, and more preferably at least 85% whole egg. In terms of ranges, the liquid egg can include whole egg content of at least 50 to 85%, 55 to 80%, 60 to 75%, and 65 to 70%.

In other embodiments, the liquid egg includes at least˜75%, preferably at least 80%, and more preferably at least 85% egg white. In terms of ranges, the liquid egg can include egg white content of at least 50 to 85%, 55 to 80%, 60 to 75%, or even 65 to 70%.

Regardless of the constituent components of the liquid egg, the use of structuring aids such as dried egg whites and texturizers (e.g., starches and gums) typically can be minimized or avoided altogether.

The liquid egg can be a carrier for any of a variety of other edible additives such as, for example, dried egg whites, water, oil(s), starch(es), dairy products such as powdered milk, powdered proteins, spice(s) (including salt, pepper, paprika, pepper flakes, etc.), gum(s), flavorant(s), food grade acids, foam inhibiting or reducing agents, colorants, dyes, and the like. It also can have incorporated into it, before or after the initial heating described below, any of a variety of cheeses, vegetables, meats, plant fibers, and edible fibers obtained from a plant product such as a fruit, grain, seed, etc. (For further information on the latter, the interested reader is directed to U.S. Pat. No. 9,913,488.)

The liquid egg can be pasteurized so as to reduce the number of viable microbes present in the liquid egg. The heating and handling involved in pasteurizing the liquid egg preferably occurs in a manner consistent with that described in G. W. Froning et al., International Egg Pasteurization Manual (2002; United Egg Assn. of Alpharetta, Ga.).

Unless the liquid egg is used soon after pasteurization, it preferably is stored at a refrigeration temperature of from 0.5° to 7° C. (˜33° to ˜45° F.), typically from 2° to 4° C. (˜35° to ˜40° F.).

Although not absolutely required, staging the liquid egg to an elevated temperature which is below a cooking temperature yet sufficiently high enough to prevent heat shock of the liquid egg product and to reduce textural non-uniformity in the final, fully cooked egg product is preferred. A target staging temperature commonly is in the range of from 52° to 67° C. (˜125° to ˜152° F.), typically from 54° to 66° C. (˜130° to ˜150° F.), and preferably 60°±2.5° C. (140°±5° F.). However, the target staging temperature can also be in the range of from 55° to 65° C. (˜131° to ˜149° F.), from 56° to 64° C. (˜133° to ˜147° F.), from 57° to 63° C. (˜135° to ˜145° F.), from 58° to 62° C. (˜136° to ˜144° F.), or from 59° to 61° C.(˜138° to ˜142° F.). These types of staging temperatures easily can be achieved by any of a variety of heat exchanger systems, with dwell times on the order of 100 to 1500 seconds.

As mentioned above, edible additives can be added to this staged liquid egg, either in addition to or in place of being added prior to this heat staging step.

Regardless of whether staged, the liquid egg mixture is cooked. In a commercial manufacturing setting, this typically is done in one of two styles of ovens, with each being discussed separately below. For safety and regulatory compliance considerations, any cooking process must provide a combination of temperature and duration that provides a cooked product having a temperature of 71° to 74° C. (˜160° to ˜165° F.), although a slightly higher temperature, e.g., 76° to 77° C. (˜170° F.), can be desirable so as to provide a margin for safety.

Cooking can occur in a mold-type oven. Heated, high velocity air is introduced around pans, molds or other containers in which the liquid egg is deposited. The humidity of the oven's interior can be maintained above a targeted minimum by introducing steam.

Operating temperatures in such ovens vary widely although, for example, from 157° to 260° C. (˜315° to ˜500° F.) is common. Operating temperatures may also vary from 175° to 250° C. (˜347° to ˜482° F.), or even 200° to 225° C. (˜392° to ˜437° F.).

The operating speeds of such ovens are such that the egg-containing molds spend from ˜95 to 180 seconds in the heating zone(s), commonly from 100 to 170 seconds, more commonly from 110 to 160 seconds, and typically from 120 to 150 seconds. Given the size of most commercial mold-type ovens, this permits operating volumes approaching 0.6 kg/sec (4500 to 4700 lbs/hr).

For additional information on the operation of such ovens, the interested reader is directed to, for example, U.S. Pat. Nos. 6,524,638, 9,781,948, and 10,251,414.

Alternatively, cooking can occur in a belt-type oven. A continuous (e.g., looped) moving surface with a nonstick coating (e.g., PTFE) has liquid egg deposited thereon and moves between heated surfaces which act to cook the liquid egg. Use of a belt-type oven results in a layer of cooked egg having a relatively uniform thickness.

Operating temperatures in such ovens can vary widely although, for example, from 149° to 315° C. (˜300° to ˜600° F.) is common; nevertheless, systems operating at lower throughput speeds can employ lower cooking temperatures.

The operating speeds of such ovens are such that any given aliquot of liquid egg spends from ˜85 to 170 seconds in the heating zone(s). Given the size of most commercial mold-type ovens, this permits operating volumes of up to 0.3 kg/sec (˜2500 lbs./hr.).

For additional information on the operation of such ovens, the interested reader is directed to, for example, U.S. Pat. No. 9,888,710.

In prior production processes, cooked egg product was diced, either immediately or soon after completion of the cooking process.

In contrast, the present process involves having the cooked egg conveyed to a location where the temperature of the cooked egg product can be reduced significantly and, preferably, in a relatively short amount of time. In other words, interposition between cooking and dicing of a controlled cooling step results in egg products having bespoke shapes and minimized fines.

An exemplary cooling device is a spiral freezer, which is a device that includes an evaporator and circulation fans. Cooked egg is carried through the freezer on a mesh conveyor that runs around a drum and up-and-down through the freezer before exiting. Dwell time in a spiral freezer is based on the arriving quantity/rate and the desired exiting temperature.

Depending on the desired appearance of the final diced egg product, typical product temperatures upon exiting the cooling device are from ˜23° to 4° C. (approximately ˜10° to 39° F.), with ˜15° to ˜7° C. (5° to 20° F.) being preferable and ˜13° to ˜11° C. (8.5° to 12° F.) being most preferred. If the exit temperature of the cooled egg is too low, increased shattering can result in higher amounts of undesirable fines.

The cooled egg product can be delivered from the cooling device to the dicer or it can be stored for later processing.

Cooled egg product is cut, chopped, minced, etc., with a dicer, which is machine having multiple cutting stages, as well as multiple blade styles and shapes, so as to permit flexibility in the shape and size of the product. A variety of dicer models are available from commercial suppliers such as, for example, Urschel Laboratories, Inc. (Chesterton, Ind.). Throughput depends on the particular model employed as well as feed rate capabilities, often ranging from 0.4 to 2 kg/sec (˜3,500 to ˜17,000 lbs/hr).

A dicer can be programmed to provide an output within a targeted dimension range. In the practice of the present method, an acceptable dimension range is 0.25 to 7.5 cm (˜0.1 to ˜3 in.) with 0.6 to 5 cm (˜0.25 to ˜2 in.) being preferred and 1.25 to 2.5 cm (˜0.5 to ˜1 in.) being most preferred. A representative target dicer output range is from 0.6 to 2.5 cm (˜0.25 to 1 in.).

A fortuitous result of reversing the order of mechanical manipulation (e.g., dicing) and cooling of the cooked egg product is that the process results in manageable, even desirable, curd shapes, yet very few fines. The aforedescribed process results in no more than 5.5%, preferably no more than 5.3%, more preferably no more than 5.1%, even more preferably no more than 4.9%, still more preferably no more than 4.7%, and most preferably no more than 4.5% fines. This compares favorably with most production techniques, which U.S. Pat. No. 9,888,710 describes as resulting in from 3.5 to 10% fines in their final cooked egg product.

The resulting egg curds can be provided with a regular shape (e.g., like cheese cubes). More commonly, they can be provided with an irregular shape, typical of home kitchen scrambled eggs. Either way, each resulting curd has a diameter along its long axis of less than ˜2.5 cm (1 inch), less than ˜2 cm (0.8 inch), less than ˜1.5 cm (0.6 inch), less than ˜1 cm (0.4 inch), or even less than ˜0.5 cm (0.2 inch).

Diced egg product typically is packaged and stored in a freezer until being shipped to a purchaser for incorporation into a final consumable product.

In brief summary, the foregoing describes a method of providing cooked eggs with a small number of fines which involves (a) cooking liquid egg at a temperature of from about 71° to 74° C. to produce a fully cooked egg product, (b) cooling the fully cooked egg product to a product temperature between about −23° to 4° C. to produce a fully cooked and cooled egg product, and (c) dicing the fully cooked and cooled egg product to produce a final egg product having curds and a minimum number of fines.

A concrete example of the aforedescribed process follows.

The following ingredients, all in w/w percentages, can be introduced to a vessel capable of high shear mixing: 60% liquid eggs, 15% water, 10% vegetable oil, 7% starch, 5% dairy, and 3% additives.

If heating and cooking capacity is not immediately available, the blended mixture can be held in a refrigerated storage tank.

Using a positive pump, the blended mixture can be moved through a shell-and-tube heat exchanger (available from, for example, Feldmeier Equipment, Inc., of Syracuse, N.Y.) to increase its temperature to 63° C. (˜145° F.). Where a mold oven is employed, further pre-heating is optional, but, where a belt-type oven is employed, the heated mixture can be conveyed through a swept surface heat exchanger to increase its temperature to 71° C. (˜160° F.).

Pre-heated mixture was conveyed to a volumetric depositor where an appropriate amount (typically 60-65 g) can be applied to a nonstick molded pan or conveying belt. Deposited liquid egg mixture can be continuously cooked at 190° C. (˜375° F.) for ˜180 seconds.

Cooked egg then can be conveyed to a spiral freezer where, over the course of ˜30 minutes, it can cool to a target temperature of ˜12° C. (˜10° F.).

Cooled cooked egg product prepared according to such a process was gravity fed into a chute attached to an Urschel Laboratories dicer having variable speed and cut size capabilities. (The particular dicing models and conditions employed are tabulated below.)

Diced product exited the dicer into a lined corrugated case.

A RO-TAP™ sieve shaker (W. S. Tyler Co.; Mentor, Ohio) was used to evaluate the curd size distribution of portions of the recovered product. The setup of the sieves in the shaker is set forth in the following table.

TABLE 1
Sieves employed

| | sieve | mm | inches |
|---|---|---|---|
| first | ⅞″ | 22.2 | 0.875 |
| second | ¾″ | 19.1 | 0.75 |
| third | ½″ | 12.7 | 0.5 |
| fourth | ¼″ | 6.4 | 0.25 |
| fifth | #5 | 4.0 | 0.157 |
| sixth | #7 | 2.8 | 0.111 |
| pan | | | |

Each test was performed in triplicate, with the resulting fine percentage representing the mean of the three tests on a given lot.

TABLE 2
Dicing conditions and results

| | Dicer | | | | Product | | | |
|---|---|---|---|---|---|---|---|---|
| | | | | | | Weight, | Weight, | % |
| | Model | Slice | Circular | Crosscut | Identity | total (g) | fines (g) | fines |
| 1 | A | C | F | I | M | 2869.6 | 139.51 | 4.86 |
| 2 | A | C | F | I | N | 3513.3 | 153.79 | 4.38 |
| 3 | A | D | G | J | M | 4502.7 | 223.59 | 4.97 |
| 4 | A | D | G | J | N | 4899.2 | 239.99 | 4.90 |
| 5 | B | E | H | K | M | 4469.5 | 222.75 | 4.98 |
| 6 | B | E | H | K | N | 4970.8 | 254.29 | 5.12 |
| 7 | B | E | H | L | M | 4449.0 | 193.89 | 4.36 |
| 8 | B | E | H | L | N | 5616.3 | 260.34 | 4.64 |

In Table 2,
A = DiversaCut ™ 2110A dicer
B = Affinity ™ dicer
C = 43037 long slot, blunt knife at 1.75 cm (11/16 in.)
D = 43037 long slot, 3HL blunt knife at 2.5 cm (1 in.)
E = 83342 stepped knife, 3HL at full open
F = 42712 1.6 cm (5/8 in.) HD assembly, alternating 42759 knives and 43061 discs in aggressive position
G = 42713 1.9 cm (3/4 in.) HD assembly, alternating 42759 knives and 43061 discs in aggressive position
H = 1.9 cm (3/4 in.) HD circular, 5.6 cm (2.2 in.) OD assembly, alternating 83339 knives and project 1150-02 discs in aggressive position
I = 42628 2.5 cm (1 in.) HD assembly
J = 42757 1.9 cm (3/4 in.) HD assembly
K = 83105 4 kn HD crosscut @ 50 Hz
L = 83332 6 kn HD crosscut @ 35 Hz
M = scrambled egg patty
N = fried egg patty

Two versions of cooled and diced cooked egg product provided according to the aforedescribed process (B1 and B2) were tested for firmness, along with two commercially available products (A1 and A2). The former differed in terms of the dicing used, while each of the latter was used in as-provided form.

At least two samples for each of the four products were tested.

The analysis was conducted using a texture analyzer from Food Technology Corp, which is a fully programmable computer-operated test system. This equipment provides an objective measure directly related to a food's mechanical performance or behavior by compressing or stretching a food sample through use of a load cell to measure the food's force response to deformation. This type of analyzer permits the amount of resistive force provided by a sample to be plotted against the distance traveled by its load cell. Other texture analyzers are available and can be used.

The analyzer was fitted with a 1.14 kg (˜2.5 pound) 10 blade, shearing, non-cutting upper blade holder unit and a Kramer shear cell. The Kramer shear cell is a multi-bladed fixture designed to produce shear stresses in a specimen that relates to firmness. This type of shear cell compresses a specimen causing deformation. The force required to move the blades relates to texture (i.e., compression, extrusion, shear), providing additional information about texture properties. Use of other shear cells also is contemplated.

For each of the samples, 150 g of egg curd was placed in the shear cell. The blade holder was lowered onto each of these curds at a rate of 3.33 mm/sec (2 cm/min).

The analyzer's output for each of the samples was recorded.

For each of the samples, the area under its load vs. distance curve (a unitless value) for the distance range of 20 to 80 mm, measured from the point where the blade holder first contacted the curd sample, was determined. For each of A1, A2, B1 and B2, the mean of the area measurements are presented below in Table 3.

Also presented in Table 3 are the mean values for peak load (i.e., the point where the load cell received the most resistance to movement) determined for each of the four test egg products.

TABLE 3
texture analysis

| | Peak load, average (N) | Area between 20-80 mm, average |
|---|---|---|
| A1 | 604.6 | 4728 |
| A2 | 531.3 | 3883 |
| B1 | 777.9 | 4957 |
| B2 | 783.2 | 5115 |

Samples B1 and B2 compare favorably in terms of peak load and overall area relative to the two commercially available products (A1 and A2), neither of which was made according to the inventive process.

The foregoing has been presented by way of example only. Certain features of the described methods may have been described in connection with only one or a few such methods, but they should be considered as being useful in other such methods unless their structure or use is incapable of adaptation for such additional use. Also contemplated are combinations of features described in isolation.

1. A method of processing liquid egg to minimize the production of fines while providing curds of cooked egg, said method comprising:
a) heating said liquid egg to a temperature of from about 71° to 77° C. to provide a fully cooked egg product;
b) cooling said fully cooked egg product to a temperature of from about −23° to 4° C. to provide a cooled egg product; and
c) mechanically manipulating said cooled egg product to provide said curds.

2. The method of claim 1 wherein the liquid egg is pasteurized.

3-6. (canceled)

7. The method of claim 1 wherein the cooled egg product temperature is from about −15° to −7° C.

8. The method of claim 1 wherein the cooled egg product temperature is from about −13° to −11° C.

9. (canceled)

10. The method of claim 1 wherein said cooked egg product is conveyed to a spiral freezer.

11. The method of claim 10 wherein said mechanical manipulation includes or is dicing.

12. The method of claim 1 wherein said mechanical manipulation includes or is dicing.

13. (canceled)

14. The method of claim 1 wherein said heating comprises subjecting said liquid egg on a continuous moving surface to a temperature of from 149° to 315° C.

15. The method of claim 1 wherein said liquid egg has a temperature of from 54° to 66° C. prior to said heating.

16. The method of claim 1 wherein said cooked egg product reaches a temperature of from 71° to 74° C.

17. The method of claim 1 wherein said cooked egg product reaches a temperature of from 76° to 77° C.

18. The method of claim 1 wherein said curds comprise no more than
5.5% (w/w) fines.

19. The method of claim 18 wherein said curds comprise no more than
4.9% (w/w) fines.

20. A process for minimizing the production of fines while providing curds of cooked egg, said process comprising:
a) providing liquid egg at a temperature of from 54° to 66° C.;
b) heating said liquid egg to a temperature of from about 71° to 77° C. to provide a fully cooked egg product;
c) in a spiral freezer, cooling said fully cooked egg product to a temperature of from about −13° to −11° C. to provide a cooled egg product; and
d) dicing said cooled egg product to provide said curds,
wherein fines constitute no more than 4.9% (w/w) of said curds.

21. The process of claim 20 wherein said liquid egg is free of structuring aids and texturizers.

22. The process of claim 20 wherein said heating comprises subjecting said liquid egg on a continuous moving surface to a temperature of from 149° to 315° C.

23. The process of claim 20 wherein said liquid egg is provided at a temperature of from 57.5° to 62.5° C.

24. The method of claim 15 wherein said liquid egg has a temperature of from 57.5° to 62.5° C. prior to said heating.

25. The method of claim 1 wherein said liquid egg is free of structuring aids and texturizers.

26. A method for providing curds of cooked egg having a reduced number of fines while, said method comprising:
a) providing liquid egg free of structuring aids and texturizers at a temperature of from 57.5° to 62.5° C.;
b) on a continuous moving surface, subjecting said liquid egg to a heating temperature of from 149° to 315° C. to provide a fully cooked egg product having a temperature of from about 71° to 77° C.;
c) in a spiral freezer, cooling said fully cooked egg product to a temperature of from about −13° to −11° C. to provide a cooled egg product; and
d) dicing said cooled egg product to provide said curds,
wherein fines constitute no more than 4.9% (w/w) of said curds.
